(19) United States
(12) Patent Application Publication
(10) Pub. No.: US 2008/0279791 A1
(43) Pub. Date: Nov. 13, 2008

(54) Use of Isoeugenol Methyl Ester as an Agent Against Bad Breath

(75) Inventors: Jurgen Rabenhorst, Hoxter (DE); Arnold Machinek, Holzminden (DE); Steffen Sonnenberg, Holzminden (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: SYMRISE GMBH & CO. KG, Holzminden (DE)

(21) Appl. No.: 11/575,906

(22) PCT Filed: Sep. 20, 2005
(86) PCT No.: PCT/EP05/54702

§ 371 Date: Mar. 23, 2007

Related U.S. Application Data
(60) Provisional application No. 60/613,022, filed on Sep. 24, 2004.

(51) Int. Cl. A61Q 11/00

(52) U.S. Cl. 424/58; 424/49

(57) ABSTRACT

The use of isoeugenol methyl ether is described as an agent (i) to inhibit and/or prevent the growth of and/or to destroy micro-organisms causing bad breath and/or (ii) to combat bad breath.

The invention concerns the use of isoeugenol methyl ether as an agent against bad breath, together with corresponding processes. The invention also concerns oral hygiene products containing isoeugenol methyl ether.

The healthy human mucosa of the oral and pharyngeal cavity and the solid tooth substance are populated with large numbers of non-pathogenic micro-organisms. This so-called microflora in the oral cavity is not only harmless but also provides important protection against opportunistic or pathogenic bacteria. A substantial problem of oral hygiene is bad breath, also known as halitosis or foetor ex ore. This odour is formed by the breakdown of food residues and dead cells in the mucosa by micro-organisms. Infestation with gram-positive and gram-negative bacteria causes bad breath. Causes cited in the literature are above all anaerobic gram-negative bacteria (e.g. Bad Breath—A multidisciplinary Approach. Eds: D. van Steenberghe, M. Rosenberg, Leuven University Press, Leuven 1996; 111-121). Since social contacts are often impaired by bad breath, those affected by it have a strong interest in remedying or preventing it.

A distinction must be made here between halitosis and pathological stomatitis (Stomatitis ulcerosa). Whereas halitosis is a normal feature of human breath and so is merely a cosmetic problem, stomatitis is a disease. It is associated with a characteristic, extremely unpleasant odour in the breath.

The object of the present invention was to find substances and agents which are effective against bad breath or against the micro-organisms involved in its formation.

Isoeugenol methyl ether (methyl isoeugenol, 1,2-dimethoxy-4-propenyl benzene, CAS No. 93-16-3) is known per se and can be represented by the following formulae:

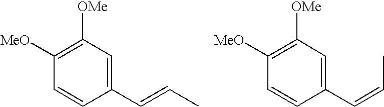

Within the context of the present invention, cis-isoeugenol methyl ether, trans-isoeugenol methyl ether or any mixture of cis and trans isomers can be used. In our own investigations, mixtures comprising 70 to 95 wt. % of trans-isoeugenol methyl ether and 30 to 5 wt. % of cis-isoeugenol methyl ether were used in particular.

The odour of isoeugenol methyl ether can be described as spicy and mildly clove-like.

Isoeugenol methyl ether is contained in small quantities in various essential oils. Depending on its origin, citronella grass oil (Cymbopogon nardus, citronella oil), in addition to its main constituents citronellal, citronellol and geraniol, contains inter alia geranyl acetate and many other components. There are two types of citronella grass oil: the Java type and the Sri Lanka (Ceylon) type, the main producing areas for the Java type being not only Indonesia but also China and Taiwan. The oil which is most widely used and which is more valuable in perfumery is the Java type, which contains no isoeugenol methyl ether. The aromatically less valuable Sri Lanka citronella grass oil differs from the Java type in that it has a content of isoeugenol methyl ether, which is routinely in the range from 7 to 11 wt. % (DIN/ISO 3849-2000).

WO 99/18940 (corresponds to U.S. Pat. No. 6,197,288) concerns a process and oral hygiene preparations for combating bad breath using mixtures of individual malodour-concealing compounds from the area of perfumes and aromatic substances. This is not an antimicrobial mode of action but an olfactory masking/concealing of the malodour. Examples of masking substances which are cited include geraniol, geranyl acetate, L-citronellol, eugenol and many other individual compounds. In a preferred embodiment, a mixture of aromatic substances to combat bad breath should contain about 0.1 wt. % of citronella grass oil, the regional origin of which is not stated. It can therefore be assumed that there was no isoeugenol methyl ether content. According to WO 99/18940, a citronella grass oil-containing mixture of aromatic substances is used in representative oral hygiene preparations in a quantity of only 0.03 to 0.1 wt. %.

U.S. Pat. No. 3,947,570 discloses an oral hygiene preparation containing 0 to 25% alcohol and around 1 to 2 wt. %, relative to the amount of alcohol used in the preparation, of an aroma acting as a denaturant. Along with many other aromas, citronella grass oil is also cited, with no mention of its regional origin. It can therefore be assumed that there was no isoeugenol methyl ether content.

DE 19612340 (corresponds to U.S. Pat. No. 6,514,551) describes a process for improving the shelf life of and/or for stabilising products which can be spoiled by micro-organisms, using a processing aid which contains at least one microbicidally active aromatic substance, wherein among a large number of aromatic substances, the compounds eugenol, isoeugenol and methyl eugenol, which are structurally related to isoeugenol methyl ether, are also mentioned. This processing aid can be used for example in the form of lubricants, emulsifiers and detergents and as cutting or separating fluids. In this case only the surfaces or cut surfaces of the foods are treated with the processing aids. The activity against various micro-organisms, in particular spoilage micro-organisms (e.g. A. niger, Enterobacter, Lactobacilli), was investigated, although this plays no part in the formation of bad breath.

The present invention primarily concerns the use of isoeugenol methyl ether as an agent (i) to inhibit and/or prevent the growth of and/or to destroy micro-organisms causing bad breath and/or (ii) to combat bad breath.

The present invention also concerns a process to inhibit and/or to prevent the growth of and/or to destroy micro-organisms causing bad breath, with the following step:
Bringing micro-organisms causing bad breath into contact with a quantity of isoeugenol methyl ether which is antimicrobially effective against these micro-organisms.

The invention also concerns a process for combating bad breath, with the following step:
Introducing a quantity of isoeugenol methyl ether which is antimicrobially effective against micro-organisms causing bad breath into the oral cavity and/or pharyngeal cavity.

The invention also concerns an oral hygiene product containing isoeugenol methyl ether in a quantity of at least 0.01 wt. %, relative to the total weight of the oral hygiene product.

Other advantageous embodiments of the invention can be seen from the claims, the description below and the examples.

In the present text, oral hygiene products are understood to be the formulations familiar to the person skilled in the art for cleaning and caring for the oral cavity and the pharyngeal cavity and for freshening the breath. Known and common oral hygiene formulations are creams, gels, pastes, foams, emulsions, suspensions, aerosols, sprays and also capsules, granules, pastilles, tablets, sweets or chewing gums, wherein this list of pharmaceutical forms and possible uses is not intended to be limiting. Such formulations serve to clean and care for the tooth substance and oral cavity and to freshen the breath.

The isoeugenol methyl ether for use according to the invention is a compound which can be incorporated largely universally into a very wide range of pharmaceutical forms of oral hygiene products, without having to be predefined for one or a few specific pharmaceutical forms, in other words isoeugenol methyl ether is compatible with many conventional cosmetic auxiliary substances and additives.

It has also been found that isoeugenol methyl ether can both effectively reduce or eliminate bad breath and also prevent its formation, i.e. can also act preventively.

It has further been found that the oral hygiene products according to the invention are effective for a relatively long period, in the order of at least three hours, without any perceptible reduction in their effect.

Isoeugenol methyl ether effectively combats bad breath, without significantly damaging the physiological flora of the oral cavity and pharyngeal cavity.

The prior art provided no mention of the use according to the invention of isoeugenol methyl ether as an agent to reduce or eliminate bad breath or to prevent the formation of bad breath.

It was found that isoeugenol methyl ether can wholly or partly prevent the growth in the oral cavity and pharyngeal cavity of gram-positive and gram-negative bacteria which are responsible for bad breath.

It was found that isoeugenol methyl ether can wholly or partly prevent the formation of components forming bad breath.

In particular, isoeugenol methyl ether is able to inhibit and/or prevent the growth of micro-organisms causing bad breath selected from the group comprising: Eubacterium, Fusobacterium, Haemophilus, Neisseria, Porphyromonas, Prevotella, Treponema and Veillonella species, in particular Fusobacterium nucleatum, Porphyromonas endodontalis, Porphyromonas gingivalis, Prevotella intermedia, Prevotella loeschii and Treponema denticola.

Isoeugenol methyl ether is characterised in particular by a very good action against anaerobic and microaerophilic bacteria.

It was also astonishing that isoeugenol methyl ether is particularly effective against the especially pronounced morning bad breath which is typically discerned in the morning after getting up.

It has been found in addition that isoeugenol methyl ether can wholly or partly prevent the deterioration of oral hygiene products by infestation with gram-positive and/or gram-negative bacteria if it is added to these products in an effective quantity. Isoeugenol methyl ether can thus also act as a preservative at the same time.

An oral hygiene product with a content of isoeugenol methyl ether in the range from 0.01 (100 ppm) to 10 wt. %, in particular with a content of 0.025 (250 ppm) to 5 wt. %, preferably with a content of 0.05 (500 ppm) to 5 wt. %, and particularly preferably 0.06 (600 ppm) to 3 wt. %, relative to the total weight of the product, is preferred according to the invention. The use of at least 0.06 wt. % very reliably achieves a significant reduction in bad breath.

In a most particularly preferred embodiment, the content of isoeugenol methyl ether is in the range from 0.06 (600 ppm) to 1.5 wt. %, relative to the total weight of the product. In the most preferred embodiment, the content of isoeugenol methyl ether is in the range from 0.08 (800 ppm) to 1.0 wt. %.

Isoeugenol methyl ether-containing oral hygiene products are preferred which do not contain isoeugenol methyl ether in the form, i.e. as a constituent, of a citronella oil.

The flavour of isoeugenol methyl ether (in oral hygiene products), especially at elevated doses, is not always perceived as being pleasant, even though it is only slightly clove-like and medicinal.

A secondary objective in the context of the present invention was therefore to achieve a flavour modification of isoeugenol methyl ether-containing oral hygiene products according to the invention such that they have an improved, more pleasant and less clove-like and/or medicinal flavour.

This secondary object could be achieved with an oral hygiene product according to the invention containing an aroma composition comprising menthol. Menthol not only provides the cooling freshness specific to menthol but at the same time reduces the clove-like and medicinal flavour impression of isoeugenol methyl ether.

A further aspect of the present invention concerns an oral hygiene product containing 0.01 (100 ppm) to 10 wt. %, preferably 0.025 to 5 wt. %, of isoeugenol methyl ether and an aroma composition containing menthol.

An aroma composition within the meaning of the present invention contains menthol and one or more other sensorially active substances.

A ratio by weight of isoeugenol methyl ether to aroma composition in the range from 50:1 to 1:50 is preferred here, preferably from 20:1 to 1:20.

The ratio by weight of isoeugenol methyl ether to menthol, i.e. the sum of all menthol isomers, is advantageously in the range from 10:1 to 1:10, preferably in the range from 5:1 to 1:5. Of the menthol isomers, racemic menthol and I-menthol are preferred.

Menthol can be used here in pure form (natural or synthetic) and/or as a constituent of natural oils and/or menthol-containing fractions of natural oils, particularly in the form of peppermint oils such as Mentha arvensis or Mentha piperita or menthol-containing fractions thereof.

It is naturally possible and advantageous to prepare a mixture of isoeugenol methyl ether and an aroma composition comprising menthol, to then incorporate it into an oral hygiene formulation and in this way to produce an oral hygiene product according to the invention.

It has also been found that an oral hygiene product according to the invention has a further improved flavour if it contains an aroma composition which in addition to menthol includes one or more substances having an aniseed note.

Advantageous substances having an aniseed note are: anethol, anisol, aniseed oil, star anise oil and fennel oil, as well as anisaldehyde and anisalcohol. Anethol and anethol-containing essential oils are preferred.

Substances having an aniseed note, in particular anethol, give an oral hygiene product according to the invention (containing a proportion of menthol) a certain sweetness and a cleaner, softer flavour profile and at the same time reduce the clove-like and medicinal flavour impression of isoeugenol methyl ether.

The ratio by weight of isoeugenol methyl ether to anethol is advantageously in the range from 20:1 to 1:10, preferably in the range from 10:1 to 1:5.

The anethol can be used here as cis- or trans-anethol or in the form of mixtures of the isomers. Anethol can be used here in pure form (natural or synthetic) and/or as a constituent of natural oils and/or anethol-containing fractions of natural oils, particular in the form of aniseed oil, star anise oil or fennel oil or anethol-containing fractions thereof.

It has also been found that an oral hygiene product according to the invention has a further improved flavour if it contains an aroma composition which in addition to menthol and optionally one or more substances having an aniseed note also includes eucalyptol (1,8-cineol).

Eucalyptol can be used here in pure form (natural or synthetic) and/or as a constituent of natural oils and/or eucalyptol-containing fractions of natural oils, for example in the form of bay (leaf) oil, eucalyptus oils of Eucalyptus fruticetorum and/or Eucalyptus globulus and/or eucalyptol-containing fractions thereof being preferred, however.

The ratio by weight of isoeugenol methyl ether to eucalyptol is advantageously in the range from 50:1 to 1:25, preferably in the range from 30:1 to 1:10.

Eucalyptol gives an oral hygiene product according to the invention (containing a proportion of menthol) a fresh top note as well as slightly camphoraceous aspects and at the same time reduces the clove-like and medicinal flavour impression of isoeugenol methyl ether.

It has also been found that an oral hygiene product according to the invention has a further improved flavour if it contains an aroma composition which in addition to menthol and optionally one or more substances having an aniseed note and/or eucalyptol also includes at least one herbal component.

Particularly suitable as the herbal component are basil oil, camomile oil, nutmeg oil (in particular mace oil), myrrh oil, oregano oil, parsley (seed) oil, rosemary oil, sage oil (clary sage oil, Dalmatian or Spanish sage oil), thyme oil, juniper oil (in particular juniper berry oil) or fractions thereof.

It is also advantageous if the oral hygiene product according to the invention contains at least one further aromatic substance from the following group: menthone, isomenthone, isopulegol, menthyl acetate, isoeugenol methyl ether, limonene, pinene (optionally as a constituent of a Eucalyptus globulus oil), carvone (optionally as a constituent of a spearmint oil), methyl salicylate (optionally as a constituent of a wintergreen oil), thymol (optionally as a constituent of a thyme or oregano oil).

In a preferred embodiment, an oral hygiene product according to the invention contains:

0.025 to 5 wt. % of isoeugenol methyl ether and
0.05 to 10 wt. %, preferably 0.05 to 5 wt. %, of an aroma composition containing menthol and optionally one or more substances having an aniseed note and/or eucalyptol and/or one or more herbal components. The ratio by weight of isoeugenol methyl ether to menthol here is preferably in the range from 10:1 to 1:10.

The specified weights of isoeugenol methyl ether and aroma composition relate in each case to the total weight of the finished oral hygiene product.

In a further preferred embodiment, an oral hygiene product according to the invention contains:

0.06 (600 ppm) to 3 wt. % of isoeugenol methyl ether and
0.05 to 10 wt. %, preferably 0.05 to 5 wt. %, of an aroma composition containing racemic menthol and/or I-menthol, anethol, eucalyptol and optionally one or more herbal components, the ratio by weight of isoeugenol methyl ether to menthol being in the range from 10:1 to 1:10, preferably in the range from 5:1 to 1:5.

The specified weights of isoeugenol methyl ether and aroma composition relate in each case to the total weight of the finished oral hygiene product.

In the preferred embodiments of oral hygiene products according to the invention, the aroma composition preferably comprises:

5 to 80 wt. %, preferably 10 to 60 wt. %, of menthol;
1 to 25 wt. %, preferably 2 to 20 wt. %, of one or more substances having an aniseed note, preferably anethol;
0.5 to 50 wt. %, preferably 1 to 30 wt. %, of eucalyptol;
and optionally
0.01 to 25 wt. %, preferably 0.1 to 15 wt. %, of one or more herbal components, relative in each case to the total weight of the aroma composition.

The sum of menthol, substance(s) having an aniseed note, eucalyptol and optionally herbal component(s) in the aroma composition is preferably greater than or equal to 40 wt. %, particularly preferably greater than or equal to 50 wt. %, and particularly preferably greater than or equal to 60 wt. %, relative to the total weight of the aroma composition.

The oral hygiene products preferred according to the invention containing isoeugenol methyl ether and an aroma composition comprising menthol not only prevent or combat bad breath but at the same time impart a fresh, pleasant flavour and breath.

It is advantageous to buffer the oral hygiene products according to the invention. A pH range of 3.5 to 10.0 is advantageous.

Isoeugenol methyl ether can be easily incorporated into common oral hygiene formulations for oral hygiene products. Preferred oral hygiene products are, for example, tooth creams, toothpastes, tooth gels, mouthwashes, mouth rinses, gargle liquids and mouth or breath sprays, as well as lozenges, pastilles, sweets, chewing gums, chew sweets and dental care chewing gums.

It is also possible and usually preferable to combine isoeugenol methyl ether with other ingredients, for example with other antimicrobially active substances, aromatic substances, flavourings and/or auxiliary substances.

The oral hygiene products according to the invention can contain auxiliary substances such as are conventionally used in such preparations, for example preservatives, abrasives, antibacterial agents, anti-inflammatory agents, irritation-preventing agents, irritation-inhibiting agents, antimicrobial agents, antioxidants, astringents, antiseptic agents, antistatics, binders, buffers, support materials, chelating agents, cell stimulants, cleansing agents, conditioning agents, surface-active substances, deodorising agents, softeners, bactericides, emulsifiers, enzymes, essential oils, film formers, fixers, foaming agents, foam stabilisers, substances to prevent foaming, foam boosters, gelling agents, gel-forming agents, moisture-releasing agents, moisturizing substances, moisture-retaining substances, bleaching agents, optical brighteners, dirt-repelling agents, friction-reducing agents, lubricants, opacifiers, concealing agents, brighteners, polymers, powders, proteins, polishing agents, silicones, skin-calming agents, skin-cleansing agents, skin care agents, skin-healing agents, cooling agents, skin-cooling agents, warming agents, skin-warming agents, stabilisers, suspending agents, thickeners, vitamins, oils, waxes, fats, phospholipids, saturated fatty acids, mono- or polyunsaturated fatty acids, α-hydroxy acids, polyhydroxy fatty acids, liquefiers, dyes, colour-protecting agents, pigments, aromas, flavourings, perfumes or other conventional constituents of a cosmetic or oral hygiene formulation, such as alcohols, polyols, electrolytes, organic solvents, sweeteners, sugar substitutes, silicas, calcium carbonate, calcium hydrogen phosphate, aluminium oxide, fluorides, zinc, tin, potassium, sodium and strontium salts, pyrophosphates, hydrogen peroxide, hydroxyapatites.

If the (oral hygiene) preparation is a solution or lotion, the following can be used as solvents, for example: water or aqueous solutions, oils, such as triglycerides of capric or caprylic acid, or alcohols, diols or polyols having a low C number and ethers thereof, preferably ethanol, isopropanol, propylene glycol, glycerol, ethylene glycol. Mixtures of the aforementioned solvents can naturally also be used.

Examples of flavourings or aromas which can form part of an oral hygiene product according to the invention in addition to isoeugenol methyl ether can be found for example in K. Bauer, D. Garbe, H. Surburg, Common Fragrance and Flavor Materials, 4^{th} ed., Wiley-VCH, Weinheim 2001 or in S. Arctander, Perfume and Flavor Chemicals, Vol. I and II, Montclair, N.J., 1969, self-published.

Examples of natural aromas which can be cited which can form part of an oral hygiene product according to the invention in addition to isoeugenol methyl ether are: peppermint oils, spearmint oils, mentha arvensis oils, aniseed oils, clove oils, citrus oils, camphor oils, cinnamon oils, cinnamon bark oils, wintergreen oils, eucalyptus oils, eucalyptus citriodora oils, fennel oils, ginger oils, camomile oils, caraway oils, citronella oils, limette oils, orange oils, bergamot oils, grapefruit oils, mandarin oil, rose oils, geranium oils, sage oils, parsley seed oils, yarrow oils, star anise oils, basil oils, bitter almond oils, thyme oils, juniper berry oils, rosemary oils, angelica root oils, vanilla extracts, as well as fractions thereof and ingredients isolated therefrom.

Examples of homogeneous aromatic substances which can be cited which can form part of an oral hygiene product according to the invention in addition to isoeugenol methyl ether are: anethol, menthol, menthone, isomenthone, menthyl acetate, menthyl propionate, menthofuran, mintlactone, eucalyptol (1,8-cineol), limonene, eugenol, eugenol acetate, thymol, pinene, sabinene hydrate, 3-octanol, carvone, gamma-octalactone, gamma-nonalactone, germacrene-D, viridiflorol, 1,3E,5Z-undecatriene, isopulegol, piperitone, 2-butanone, ethyl formate, 3-octyl acetate, isoamyl isovalerianate, hexanol, hexanal, cis-3-hexenol, linalool, alpha-terpineol, cis- and trans-carvyl acetate, p-cymol, damascenone, damascone, rose oxide, fenchol, acetaldehyde diethylacetal, 1-ethoxyethyl acetate, cis-4-heptenal, isobutyraldehyde, isovaleraldehyde, cisjasmone, methyl dihydrojasmonate, anisaldehyde, methyl salicylate, 2′-hydroxypropiophenone, menthyl methyl ether, myrtenyl acetate, 2-phenylethyl alcohol, 2-phenylethyl isobutyrate, 2-phenylethyl isovalerate, cinnamaldehyde, geraniol, nerol. In the case of chiral compounds the aromatic substances can take the form of a racemate or a single enantiomer or an enantiomer-concentrated mixture.

Advantageous aromas or aromatic substances which can form part of an oral hygiene product according to the invention in addition to isoeugenol methyl ether are, for example, aniseed oil, basil oil, bitter almond oil, camphor oil, citronella oil, citrus oils, eucalyptus citriodora oil, eucalyptus oil, camomile oil, spearmint oil, limette oil, mandarin oil, clove oil, orange oil, peppermint oil, sage oil, thyme oil, wintergreen oil, cinnamon oil, cinnamon bark oil, I-menthol, menthone, 1,8-cineol (eucalyptol), carvone, alpha-terpineol, methyl salicylate, 2′-hydroxypropiophenone, menthyl methyl ether.

Compounds having a physiological cooling effect (cooling substances) which can form part of an oral hygiene product according to the invention in addition to isoeugenol methyl ether are, for example, I-menthol, menthone glycerol acetal, menthyl lactate, substituted menthyl-3-carboxylic acid amides (e.g. menthyl-3-carboylic acid-N-ethylamide), 2-isopropyl-N,2,3-trimethyl butanamide, substituted cyclohexane carboxylic acid amides, 3-menthoxypropane-1,2-diol, 2-hydroxyethyl menthyl carbonate, 2-hydroxypropyl menthyl carbonate, N-acetyl glycine menthyl ester, menthyl hydroxycarboxylic acid esters (e.g. menthyl-3-hydroxybutyrate), monomenthyl succinate 2-mercaptocyclodecanone, menthyl-2-pyrrolidin-5-one carboxylate, 2,3-dihydroxy-p-menthane, 3,3,5-trimethyl cyclohexanone glycerol ketal, 3-menthyl-3,6-di- and tri-oxaalkanoates, 3-menthyl methoxyacetate, icilin, I-menthyl methyl ether. I-Menthol, menthone glycerol acetal, menthyl lactate, menthyl-3-carboxylic acid-N-ethylamide, 3-menthoxypropane-1,2-diol, 2-hydroxyethyl menthyl carbonate, 2-hydroxypropyl menthyl carbonate, monomenthyl succinate, menthyl-2-pyrrolidin-5-one carboxylate, I-menthyl methyl ether are preferred.

Oral hygiene products which in addition to I-menthol contain at least one, particularly preferably at least two, further cooling substances are preferred according to the invention.

Constituents which bring about a sensation of heat, sharpness, itching or prickling on the skin or on the mucous membranes, in particular aromatic substances having a heat-generating effect and/or compounds having a pungent taste (pungent principles), which can form part of an oral hygiene product according to the invention in addition to isoeugenol methyl ether are, for example, capsaicin, dihydrocapsaicin, gingerol, paradol, shogaol, piperine, paprika powder, chilli pepper powder, extracts of paprika, extracts of pepper; extracts of chilli pepper; extracts of ginger roots, extracts of Aframomum melegueta, extracts of Spilanthes acmella, extracts of Kaempferia galanga, extracts of Alpinia galanga, carboxylic acid-N-vanillylamides, in particular nonanoic acid-N-vanillylamide, 2-nonenoic acid amides, in particular 2-nonenoic acid-N-isobutylamide, 2-nonenoic acid-N-4-hydroxy-3-methoxyphenylamide, alkyl ethers of 4-hydroxy-3-methoxybenzyl alcohol, in particular 4-hydroxy-3-methoxybenzyl-n-butyl ether, alkyl ethers of 3-hydroxy-4-methoxybenzyl alcohol, alkyl ethers of 3,4-dimethoxybenzyl alcohol, alkyl ethers of 3-ethoxy-4-hydroxybenzyl alcohol, alkyl ethers of 3,4-methylene dioxybenzyl alcohol, (4-hydroxy-3-methoxyphenyl)acetic acid amides, in particular (4-hydroxy-3-methoxyphenyl)acetic acid-N-noctylamide, nicotinaldehyde, methyl nicotinate, propyl nicotinate, 2-butoxyethyl nicotinate, benzyl nicotinate, 1-acetoxychavicol.

Other constituents which can form part of an oral hygiene product according to the invention in addition to isoeugenol methyl ether are, for example, substances to improve oral hygiene, such as dental care and/or refreshing substances, for example. Substances to improve oral hygiene include, for example, substances to combat or prevent plaque, tartar or caries and those to combat or prevent bad breath. Reference is made in this connection to U.S. Pat. No. 5,043,154. Substances which can be cited by way of example are Zn salts, such as Zn citrate, Zn fluoride, Sn salts, such as Sn fluorides, Cu salts, fluorides, e.g. amine fluorides, alkali fluorides such as Na fluoride, alkaline-earth fluorides, ammonium fluoride, phosphates, pyrophosphates, fluorophosphates, such as Na monofluorophosphate, Al mono- and Al difluorophosphate, alpha-ionones, geraniol, thymol, isomenthyl acetate, panthenol (provitamin B₅), xylitol, allantoin, niacinamide (vitamin B₃), tocopheryl acetate (vitamin E acetate), poloxamer.

An oral hygiene product according to the invention can also contain in addition to isoeugenol methyl ether one or more other antimicrobial active ingredients to improve oral hygiene. These active ingredients can be of a hydrophilic, amphoteric or hydrophobic nature. Examples which can be cited are: triclosan, chlorhexidines and salts, peroxides, phenols and salts thereof, domiphen bromide (phenododecinium bromide), bromochlorophene, Zn salts, chlorophylls, Cu salts, Cu gluconate, Cu chlorophyll, sodium lauryl sulfate, quaternary monoammonium salts such as cocoalkyl benzyl dimethyl ammonium chloride or pyridinium salts such as cetyl pyridinium chloride. In addition to individual active ingredients, mixtures of active ingredients or natural extracts or fractions thereof containing active ingredients can be used, such as those obtainable from neem, berberis, fennel, green tea, marigold, camomile, rosemary, thyme, propolis or turmeric, for example.

In addition to isoeugenol methyl ether, an oral hygiene product according to the invention can also contain antioxidants, the following being cited here by way of example: carotenoids, carotenes (e.g. α-carotene, β-carotene, lycopene) and derivatives thereof, flavonoids, quercetin, (metal) chelators (e.g. α-hydroxy fatty acids, fatty acids (palmic acids), phytic acid, lactoferrin, EDTA, EGTA), α-hydroxy acids (e.g. citric acid, lactic acid, malic acid), folic acid and derivatives thereof, ubiquinone and ubiquinol and derivatives thereof, vitamin C and derivatives (e.g. ascorbyl palmitate, Mg ascorbyl phosphate, ascorbyl acetate), tocopherols and derivatives (e.g. vitamin E acetate), vitamin A and derivatives (vitamin A palmitate), ferulic acid and derivatives thereof, butyl hydroxytoluene (BHT), butyl hydroxyanisole, zinc and derivatives thereof (e.g. ZnO, ZnSO₄), selenium and derivatives thereof (e.g. selenium methionine); ingredients isolated from plants, extracts or fractions thereof, e.g. from tea, green tea, algae, grape seeds, wheat germ, camomile, rosemary, oregano.

In addition to isoeugenol methyl ether, an oral hygiene product according to the invention can also contain dyes, colorants or pigments, the following being cited here by way of example: lactoflavin (riboflavin), beta-carotene, riboflavin-5′-phosphate, alpha-carotene, gamma-carotene, cantaxanthin, erythrosine, curcumin, quinoline yellow, yellow orange S, tartrazine yellow, bixin, norbixin (annatto, orlean), capsanthin, capsorubin, lycopene, beta-apo-8′-carotenal, beta-apo-8′-carotenic acid ethyl ester, xantophylls (flavoxanthin, lutein, cryptoxanthin, rubixanthin, violaxanthin, rodoxanthin), fast carmine (carminic acid, cochineal), azorubin, cochineal red A (Ponceau 4 R), beetroot red, betanin, anthocyanins, amaranth, patent blue V, indigotine I (indigo carmine), chlorophylls, copper compounds of chlorophylls, acid brilliant green BS (lissamine green), brilliant black BN, vegetable carbon, titanium dioxide, iron oxides and hydroxides, calcium carbonate, aluminium, silver, gold, pigment rubine BK (lithol rubine BK), methyl violet B, victoria blue R, victoria blue B, acilan brilliant blue FFR (brilliant wool blue FFR), naphthol green B, acilan fast green 10 G (alkali fast green 10 G), ceres yellow GRN, sudan blue 11, ultramarine, phthalocyanine blue, phthalocyanine green, fast acid violet R. Other, naturally obtained extracts (e.g. paprika extract, black carrot extract, red cabbage extract) can also be used for colouring purposes.

The following examples are intended to clarify the present invention, without restricting its scope.

### EXAMPLES

Unless otherwise specified, all figures stated relate to the weight.

Two different mixtures were used: one consisted of 80 wt. % of trans-isoeugenol methyl ether and 20 wt. % of cis-isoeugenol methyl ether, the other consisted of 95 wt. % of trans-isoeugenol methyl ether and 5 wt. % of cis-isoeugenol methyl ether.

### In-Vitro Test to Reduce Bad Breath

The test is based on the work of Goldberg and Rosenberg (Production of Oral Malodor in an in vitro System, S. Goldberg and M. Rosenberg, pp. 143-150, in: Bad Breath—A multidisciplinary Approach, Eds: D. van Steenberghe, M. Rosenberg, Leuven University Press, 1996) and has been adapted to improve reproducibility.

A sterile liquid medium inoculated with fresh morning saliva is incubated for a few days at 37° C. and then sniffed by a panel of testers.

An intensive odour characteristic of bad breath has formed. Uninoculated controls have only a faint odour of the medium.

As a control for the tests, Triclosan® (5-chloro-2-(2,4-dichlorophenoxy)phenol) was added to inoculated samples in a concentration of 0.05%. After the incubation period, inoculated samples treated with Triclosan® had the same faint odour of medium as the uninoculated samples.

With the addition of 0.01% isoeugenol methyl ether to inoculated samples, no odour—just as with Triclosan®—could be determined after the incubation period. This value also corresponds to the minimum effective concentration. At concentrations of significantly less than 0.01%, a changed characteristic odour or a mixed odour was discernible in some cases.

If 0.05% isoeugenol methyl ether is added to the inoculated medium just one hour before the sensory assessment, an unpleasant mixed odour of bad breath and a faint isoeugenol methyl ether note is observed. This observation proves that the action of isoeugenol methyl ether against bad breath is not an olfactory masking/concealing action.

### Determination of the Minimum Inhibiting Concentration

The minimum inhibiting concentration (MIC) of isoeugenol methyl ether was determined in a serial-dilution test against various bacteria. The result is shown in the table below:

| Organism | MIC [ppm] | Type |
|---|---|---|
| Escherichia coli | >1000 | No action up to 1000 ppm |
| Pseudomonas aeruginosa | >1000 | No action up to 1000 ppm |
| Staphylococcus aureus | >1000 | No action up to 1000 ppm |
| Streptococcus mutans | >1000 | No action up to 1000 ppm |
| Fusobacterium nucleatum | 250 | Bacteriostatic |
| Veilonella parvula | 250 | Bacteriostatic |
| Prevotella intermedia | 500 | Bactericidal |
| Porphyromonas gingivalis | 500 | |

A bacteriostatic action against the halitosis-causing microbes Fusobacterium nucleatum and Veilonella parvula was thus demonstrated at a concentration of 250 ppm of isoeugenol methyl ether. Furthermore, a bactericidal action against the halitosis-causing microbe Prevotella intermedia was demonstrated at a concentration of 500 ppm of isoeugenol methyl ether as well as an effectiveness against Porphyromonas gingivalis at a concentration of 500 ppm of isoeugenol methyl ether.

In a further test in a concentration of 1000 ppm, isoeugenol methyl ether showed no significant reduction with regard to the total number of bacteria in the samples of saliva which were examined.

### FORMULATION EXAMPLES

### 1. Gel Toothpaste Effective Against Bad Breath

| | I (%) | II (%) | III (%) |
|---|---|---|---|
| Na carboxymethyl cellulose | 0.40 | 0.40 | 0.40 |
| Sorbitol 70%, in water | 72.00 | 72.00 | 72.00 |
| Polyethylene glycol (PEG) 1500 | 3.00 | 3.00 | 3.00 |
| Na saccharinate | 0.07 | 0.07 | 0.07 |
| Na fluoride | 0.24 | 0.24 | 0.24 |
| p-Hydroxybenzoic acid (PHB) ethyl | 0.15 | 0.15 | 0.15 |
| ester | | | |
| Aroma A | 0.80 | 1.10 | 1.00 |
| Isoeugenol methyl ether | 0.025 | 0.06 | 0.2 |
| Abrasive silica | 11.00 | 11.00 | 11.00 |
| Thickening silica | 6.00 | 6.00 | 6.00 |
| Sodium dodecyl sulfate (SDS) | 1.40 | 1.40 | 1.40 |
| Water dist. | To make | To make | To make |
| | 100.00 | 100.00 | 100.00 |

Aroma A had the following composition:

30 wt. % I-menthol, 30 wt. % peppermint oil Mentha piperita, 21.5 wt. % peppermint oil Mentha arvensis, 9 wt. % anethol, 0.5 wt. % anisaldehyde, 2 wt. % eucalyptol, 1 wt. % Eucalyptus globulus oil, 3 wt. % menthone, 1 wt. % spearmint oil, 1 wt. % basil oil, 0.5 wt. % menthyl acetate, 0.05 wt. % menthyl lactate, 0.1 wt. % menthyl-3-carboxylic acid-N-ethylamide (WS-3), 0.05 wt. % 2-hydroxyethyl menthyl carbonate (Frescolat MGC, Symrise), 0.05 wt. % 2-hydroxypropyl menthyl carbonate (Frescolat MPC, Symrise), 0.1 wt. % pinene, 0.1 wt. % propylene glycol, 0.05 wt. % limonene.

### 2. Anti-Plaque Toothpaste Effective Against Bad Breath

| | I (%) | II (%) | III (%) |
|---|---|---|---|
| Na carboxymethyl cellulose | 1.00 | 1.00 | 1.00 |
| Glycerine | 12.50 | 12.50 | 12.50 |
| Sorbitol 70%, in water | 29.00 | 29.00 | 29.00 |
| Na saccharinate | 0.20 | 0.20 | 0.20 |
| Na fluoride | 0.22 | 0.22 | 0.22 |
| Azacycloheptane-2,2-diphosphoric | 1.00 | 1.00 | 1.00 |
| acid, disodium salt | | | |
| Bromochlorophene | 0.10 | 0.10 | 0.10 |
| Peppermint aroma | 1.10 | 1.10 | 1.10 |
| Isoeugenol methyl ether | 0.025 | 0.05 | 0.15 |
| Abrasive silica | 15.00 | 15.00 | 15.00 |
| Thickening silica | 5.00 | 5.00 | 5.00 |
| Sodium dodecyl sulfate (SDS) | 1.50 | 1.50 | 1.50 |
| Water dist. | To make | To make | To make |
| | 100.00 | 100.00 | 100.00 |

### 3. Anti-Plaque Toothpaste Effective Against Bad Breath

Basis: Silica, alkali diphosphate

| | I (%) | II (%) | III (%) |
|---|---|---|---|
| Carrageenan | 0.90 | 0.90 | 0.90 |
| Glycerine | 15.00 | 15.00 | 15.00 |
| Sorbitol 70%, in water | 25.00 | 25.00 | 25.00 |
| PEG 1000 | 3.00 | 3.00 | 3.00 |
| Na fluoride | 0.24 | 0.24 | 0.24 |
| Tetrapotassium diphosphate | 4.50 | 4.50 | 4.50 |
| Tetrasodium diphosphate | 1.50 | 1.50 | 1.50 |
| Na saccharinate | 0.40 | 0.40 | 0.40 |
| Precipitated silica | 20.00 | 20.00 | 20.00 |
| Titanium dioxide | 1.00 | 1.00 | 1.00 |
| PHB methyl ester | 0.10 | 0.10 | 0.10 |
| Menthol eucalyptol aroma | 1.10 | 1.10 | 1.10 |
| Isoeugenol methyl ether | 0.05 | 0.30 | 0.50 |
| Sodium dodecyl sulfate | 1.30 | 1.30 | 1.30 |
| Water dist. | To make | To make | To make |
| | 100.00 | 100.00 | 100.00 |

### 4. Toothpaste for Sensitive Teeth Effective Against Bad Breath

| | I (%) | II (%) | III (%) |
|---|---|---|---|
| Na carboxymethyl cellulose | 0.70 | 0.70 | 0.70 |
| Xanthan gum | 0.50 | 0.50 | 0.50 |
| Glycerine | 15.00 | 15.00 | 15.00 |
| Sorbitol 70%, in water | 12.00 | 12.00 | 12.00 |
| K nitrate | 5.00 | 5.00 | 5.00 |
| Na monofluorophosphate | 0.80 | 0.80 | 0.80 |
| PHB methyl ester | 0.15 | 0.15 | 0.15 |
| PHB propyl ester | 0.05 | 0.05 | 0.05 |
| Na saccharinate | 0.20 | 0.20 | 0.20 |
| Menthol anethol aroma | 1.00 | 1.00 | 1.00 |
| Isoeugenol methyl ether | 0.025 | 0.10 | 0.20 |
| Ca carbonate | 35.00 | 35.00 | 35.00 |
| Silicon dioxide | 1.00 | 1.00 | 1.00 |
| Sodium dodecyl sulfate | 1.50 | 1.50 | 1.50 |
| (SDS) | | | |
| Water dist. | To make | To make | To make |
| | 100.00 | 100.00 | 100.00 |

### 5. Toothpaste for Sensitive Teeth Effective Against Bad Breath

| | I (%) | II (%) | III (%) |
|---|---|---|---|
| Hydroxyethyl cellulose | 1.40 | 1.40 | 1.40 |
| Guar gum | 0.60 | 0.60 | 0.60 |
| Glycerine | 18.00 | 18.00 | 18.00 |
| Sorbitol 70%, in water | 12.00 | 12.00 | 12.00 |
| Na saccharinate | 0.35 | 0.35 | 0.35 |
| Dye | 0.01 | 0.01 | 0.01 |
| PHB methyl ester | 0.15 | 0.15 | 0.15 |
| PHB propyl ester | 0.04 | 0.04 | 0.04 |
| Sr chloride | 10.50 | 10.50 | 10.50 |
| Peppermint aniseed | 1.20 | 1.20 | 1.00 |
| aroma | | | |
| Isoeugenol methyl ether | 0.025 | 0.10 | 0.25 |
| Precipitated silica | 15.00 | 15.00 | 15.00 |
| Silicon dioxide | 1.60 | 1.60 | 1.60 |
| Sodium dodecyl sulfate | 1.30 | 1.30 | 1.30 |
| Water dist. | To make | To make | To make |
| | 100.00 | 100.00 | 100.00 |

### 6. Ready-to-Use Mouthwash with Fluoride and Effective Against Bad Breath

| | I (%) | II (%) | III (%) |
|---|---|---|---|
| Ethanol | 7.00 | 7.00 | 7.00 |
| Glycerine | 12.00 | 12.00 | 12.00 |
| Na fluoride | 0.05 | 0.05 | 0.05 |
| Pluronic F-127 ® (BASF, | 1.40 | 1.40 | 1.40 |
| surface-active substance) | | | |
| Na phosphate buffer pH 7.0 | 1.10 | 1.10 | 1.10 |
| Sorbic acid | 0.20 | 0.20 | 0.20 |
| Na saccharinate | 0.10 | 0.10 | 0.10 |
| Menthol peppermint aroma | 0.15 | 0.20 | 0.15 |
| Isoeugenol methyl ether | 0.01 | 0.05 | 0.08 |
| Dye | 0.01 | 0.01 | 0.01 |
| Water dist. | To make | To make | To make |
| | 100.00 | 100.00 | 100.00 |

### 7. Concentrated Mouthwash Effective Against Bad Breath

| | I (%) | II (%) | III (%) |
|---|---|---|---|
| Ethanol, 95% | 80.00 | 80.00 | 80.00 |
| Na cyclamate | 0.15 | 0.15 | 0.15 |
| Menthol aniseed eucalyptol | 3.50 | 1.0 | 3.50 |
| aroma | | | |
| Dye | 0.01 | 0.01 | 0.01 |
| Isoeugenol methyl ether | 0.50 | 1.5 | 2.5 |
| Water dist. | To make | To make | To make |
| | 100.00 | 100.00 | 100.00 |

### 8. Chewing Gum to Prevent Bad Breath

| | I (%) | II (%) | III (%) |
|---|---|---|---|
| Chewing gum base | 21.00 | 21.00 | 21.00 |
| Glucose syrup | 16.50 | 16.50 | 16.50 |
| Glycerine | 0.50 | 0.50 | 0.50 |
| Icing sugar | 60.45 | 60.40 | 60.30 |
| Menthol spearmint aroma | 1.50 | 1.50 | 1.20 |
| Isoeugenol methyl ether | 0.05 | 0.10 | 0.50 |

### 9. Sugar-Free Chewing Gum to Prevent Bad Breath

| | I (%) | II (%) | III (%) |
|---|---|---|---|
| Chewing gum base | 30.00 | 30.00 | 30.00 |
| Sorbitol, powdered | 38.45 | 38.40 | 38.30 |
| Palatinite | 9.50 | 9.50 | 9.50 |
| Xylitol | 2.00 | 2.00 | 2.00 |
| Mannitol | 3.00 | 3.00 | 3.00 |
| Aspartame | 0.10 | 0.10 | 0.10 |
| Acesulfame K | 0.10 | 0.10 | 0.10 |
| Emulgum/emulsifier | 0.30 | 0.30 | 0.30 |
| Sorbitol 70%, in water | 14.00 | 14.00 | 14.00 |
| Glycerine | 1.00 | 1.00 | 1.00 |
| Menthol aniseed cinnamon | 1.50 | 1.50 | 1.50 |
| aroma | | | |
| Isoeugenol methyl ether | 0.05 | 0.10 | 0.20 |

### 10. Gelatine Capsule for Direct Consumption to Prevent Bad Breath

| | I (%) | II (%) | III (%) |
|---|---|---|---|
| Gelatine shell: | | | |
| Glycerine | 2.014 | 2.014 | 2.014 |
| Gelatine 240 bloom | 7.91 | 7.91 | 7.91 |
| Sucralose | 0.065 | 0.065 | 0.065 |
| Allura Red | 0.006 | 0.006 | 0.006 |
| Brilliant Blue | 0.005 | 0.005 | 0.005 |
| Core composition: | | | |
| Plant oil triglyceride | 80.0 | 70.0 | 66.0 |
| (coconut oil fraction) | | | |
| Aroma B | 7.0 | 12.0 | 12.0 |
| Isoeugenol methyl ether | 3.0 | 8.0 | 12.0 |

Aroma B had the following composition (figures in wt. %):
0.1% neotame powder, 0.05% aspartame, 29.3% peppermint oil arvensis, 29.3% peppermint piperita oil Willamette, 2.97% sucralose, 2.28% triacetin, 5.4% diethyl tartrate, 12.1% peppermint oil yakima, 0.7% ethanol, 3.36% 2-hydroxyethyl menthyl carbonate, 3.0% 2-hydroxypropyl menthyl carbonate, 0.27% vanillin, 5.5% D-limonene, 5.67% L-menthyl acetate.

The gelatine capsule suitable for direct consumption had a diameter of 5 mm and the weight ratio of core material to shell material was 90:10. The capsule opened in the mouth in less than 10 seconds and dissolved completely in less than 50 seconds.

1. A method of inhibiting the growth of micro-organisms causing bad breath and/or to combat bad breath by adding thereto to a composition comprising isoeugenol methyl ether in an amount sufficient to act as an agent (i) to inhibit and/or prevent the growth of and/or to destroy micro-organisms causing bad breath and/or (ii) to combat bad breath.

2. A method according to claim 1, wherein the micro-organisms causing bad breath are selected from the group comprising: Eubacterium, Fusobacterium, Haemosphilus, Neisseria, Porphyromonas, Prevotella, Treponema and Viellonella species.

3. An oral hygiene product containing isoeugenol methyl ether in a quantity of at least 0.01 wt. %, relative to the total weight of the product.

4. An oral hygiene product according to claim 3, containing a quantity of isoeugenol methyl ether in the range from 0.025 to 5.0 wt. %, relative to the total weight of the product.

5. An oral hygiene product according to claim 3, containing an aroma composition comprising menthol and optionally one or more substances having an aniseed note and/or eucalyptol and/or one or more herbal components.

6. An oral hygiene product according to claim 3, containing
0.025 to 5 wt. % of isoeugenol methyl ether and
0.05 to 10 wt. % of an aroma composition comprising menthol and optionally one or more substances having an aniseed note and/or eucalyptol and/or one or more herbal components.

7. An oral hygiene product according to claim 3, containing
0.06 to 3 wt. % of isoeugenol methyl ether and
0.05 to 10 wt. % of an aroma composition comprising racemic menthol and/or I-menthol, anethol, eucalyptol and optionally one or more herbal components, the ratio by weight of isoeugenol methyl ether to menthol being in the range from 10:1 to 1:10.

8. A process to inhibit and/or to prevent the growth of and/or to destroy micro-organisms causing bad breath, comprising the following step:
bringing micro-organisms causing bad breath into contact with a quantity of isoeugenol methyl ether which is antimicrobially effective against these micro-organisms.

9. A process for combating bad breath, comprising the following step:
introducing a quantity of isoeugenol methyl ether which is antimicrobially effective against micro-organisms causing bad breath into the oral cavity and/or pharyngeal cavity.
